(19) United States
(12) Patent Application Publication
(10) Pub. No.: US 2015/0329069 A1
(43) Pub. Date: Nov. 19, 2015

(54) CONDUCTOR HARNESS ASSEMBY HAVING A FLEXIBLE SHEATH

(71) Applicant: DELPHI TECHNOLOGIES, INC., Troy, MI (US)

(72) Inventors: JAMES D. DAUGHERTY, BROOKFIELD, OH (US); DAVID R. PETERSON, AURORA, OH (US); RITA P. ROWE, CORTLAND, OH (US)

(73) Assignee: DELPHI TECHNOLOGIES, INC., Troy, MI (US)

(21) Appl. No.: 14/277,102

(22) Filed: May 14, 2014

(51) Int. Cl. B60R 16/02

(52) U.S. Cl. CPC B60R 16/0215; B33Y 10/00

(57) ABSTRACT

A conductor harness assembly having a main trunk that branches into a first and second branch and a unitary sheath that is formed of a flexible material. A first, second, and third portion of the sheath is circumferentially wrapped about the main trunk, the first branch and the second branch respectively. The sheath may be formed of a woven cloth material, a thermoelastic material, or a combination of the two. The sheath may include attachment features such as barbed pins formed integrally with the sheath.

### TECHNICAL FIELD OF THE INVENTION

The invention generally relates to conductor harness assembly, and more particularly relates to a conductor harness assembly enclosed within a flexible sheath.

### BACKGROUND OF THE INVENTION

Conductors are often bundled together for ease of manufacture, installation and service. In, automotive and light truck applications bundled electrical wires and other required components (metal terminals and plastic components) are commonly referred to as wiring assemblies or wiring harness assemblies. The bundled wires are typically wrapped with a variety of vinyl and/or cloth tapes to secure bundled wires, protect wires, and attach other components or coverings.

There are a wide variety of types of tapes, coverings, and application methods used to give wiring assemblies desired characteristics. These characteristics include wiring assembly flexibility, stiffness, abrasion protection, and softness to decrease squeaks and rattles.

Because of the many different types of tapes and coverings and the typically manual application methods, wire covering is considered high in material and labor costs relative to the total production cost of the wiring assembly.

One additional wiring assembly component type that is not considered covering is attachment clips. Attachment clips are secured to the wiring assembly and used to attach the wiring assembly to a substrate in the vehicle. This attachment serves to route the wiring assembly in the vehicle and position it away from moving parts, high heat sources or other potently harmful conditions.

Wiring assembly attachment clips are typically secured to wiring assemblies using one of two different methods. The attachment clip may include an integral attachment features that secures the clip to the wiring assembly or the attachment clip may be secured to the wiring assembly using tape.

The current covering application method and attachment application method requires that wires are routed on an assembly fixture as a first step. The main branch or wiring assembly trunk and outlet branches are then controlled or contained using manually applied tapes from rolls, loose piece wraps, and tubing.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with one embodiment of this invention, a conductor harness assembly is provided. The conductor harness assembly includes a main trunk having a first plurality of conductors and a second plurality of conductors. The main trunk branches into a first branch and a second branch. The first branch and the second branch extend from the main trunk. The first branch includes the first plurality of conductors and the second branch includes the second plurality of conductors. The conductor harness assembly further includes a substantially planar sheath formed of a flexible material and defining a first portion having a length and width corresponding to a length and circumference of the first branch, a second portion having a length and width corresponding to a length and circumference of the second branch, and a third portion having a length and width corresponding to a length and circumference of the main trunk. The first portion is circumferentially wrapped about the first branch, the second portion is circumferentially wrapped about the second branch, and the third portion is wrapped about the main trunk.

The sheath may be formed of a woven fabric material or a thermoelastic material. The sheath may be formed by a molding process or an additive manufacturing process. A segment of the sheath may be formed of different material than the flexible material forming the remainder of the sheath and/or may have a different thickness than the flexible material forming the remainder of the sheath. The first plurality of conductors may be a first plurality of wires and the second plurality of conductors may be a second plurality of wires. The conductor harness assembly may also include an attachment means that is integral to the sheath.

In another embodiment of the present invention, a wire harness assembly is provided. The wire harness assembly includes a main trunk having a first plurality of wires and a second plurality of wires. The main trunk branches into a first branch and a second branch. The first branch and the second branch extend from the main trunk. The first branch includes the first plurality of wires and the second branch includes said second plurality of wires. The wire harness assembly also comprises a substantially planar sheet of a flexible material defining a pattern including a first portion having a length and width corresponding to the length and circumference of the first branch, a second portion having a length and width corresponding to the length and circumference of the second branch, and a third portion having a length and width corresponding to the length and circumference of the main trunk, wherein the first portion is circumferentially wrapped about the first branch, the second portion is circumferentially wrapped about the second branch, and the third portion is wrapped about the main trunk. A distal edge of the first portion overlaps an opposing distal edge of the first portion and is joined to the opposing distal edge, a distal edge of the second portion overlaps an opposing distal edge of the second portion and is joined to the opposing distal edge, and a distal edge of the third portion overlaps an opposing distal edge of the third portion and is joined to the opposing distal edge. Each distal edge may be joined to each opposing distal edge by an adhesive material.

The sheath may be formed of a thermoelastic material. The sheath may be formed by a molding process. The wire harness assembly may further include an attachment means that is formed of a different material than the sheath and is formed integrally with the sheath. Alternatively, the sheath and the attachment means may be formed by an additive manufacturing process. A segment of the sheath may be formed of different material than the flexible material forming the remainder of the sheath and/or may have a different thickness than the flexible material forming the remainder of the sheath.

In yet another embodiment of the present invention, a wire harness assembly is provided. The wire harness assembly comprises a main trunk having a first plurality of wires and a second plurality of wires. The main trunk branches into a first branch and a second branch. The first branch and the second branch extend from said main trunk. The first branch includes the first plurality of wires and the second branch includes the second plurality of wires. The wire harness assembly further comprises a fabric material defining a pattern including a first portion having a length and width proportional to the length and circumference of the first branch, a second portion having a length and width proportional to the length and circumference of the second branch, and a third portion having a length and width proportional to the length and circumference of the main trunk, wherein the distal edges of the first portion are joined to circumferentially wrap the first branch, the distal edges of the second portion are joined to circumferentially wrap the second branch, and the distal edges of the third portion are joined to circumferentially wrap the main trunk. A distal edge of the first portion overlaps an opposing distal edge of the first portion and is joined to the opposing distal edge, a distal edge of the second portion overlaps an opposing distal edge of the second portion and is joined to the opposing distal edge, and a distal edge of the third portion overlaps an opposing distal edge of the third portion and is joined to the opposing distal edge. Each distal edge may be joined to each opposing distal edge by an adhesive material.

A segment of the sheath may be formed of different material distinct from the fabric material forming the remainder and/or formed of a different fabric material having a different thickness than the fabric material forming the remainder of the sheath.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1 is a top view of a conductor harness assembly in an unassembled condition in accordance with one embodiment;

FIG. 2 is a top view of a conductor harness assembly in an assembled condition in accordance with one embodiment; and

FIG. 3 is a top view of a sheath configured for use in a conductor harness assembly in accordance with another embodiment.

### DETAILED DESCRIPTION OF THE INVENTION

A flexible sheath that is used to wrap a bundle of conductors is presented herein. This flexible sheath would be uniquely designed for each specific type of conductor harness assembly or unique conductor harness assembly part number. The flexible sheath could also be designed to be used as a substrate for attachment features used to attach the conductor harness assembly to a structure.

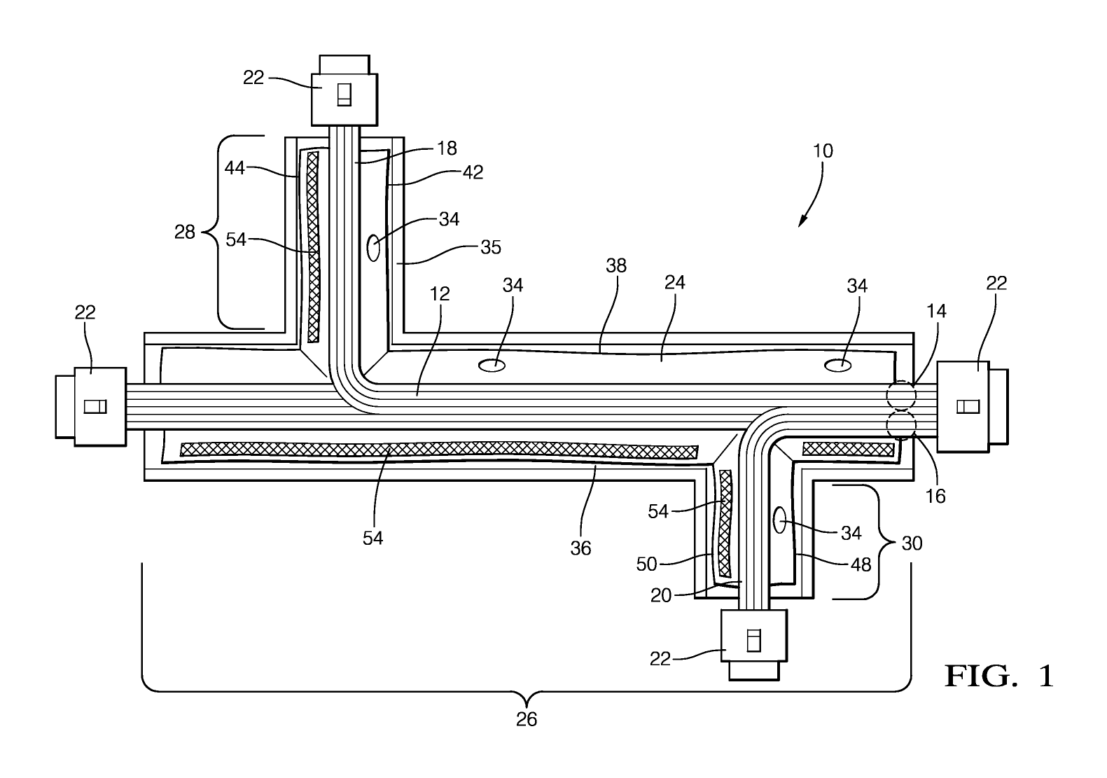

FIG. 1 illustrates a non-limiting example of a conductor harness assembly 10. The conductor harness assembly 10 includes a main trunk 12 that has a first plurality of conductors 14 and a second plurality of conductors 16. In the illustrated example, the conductor harness assembly 10 is a wire harness assembly 10 such as those used to distribute electrical power and electrical signals in a motor vehicle and so the first plurality of conductors 14 is a first plurality of wires 14 and the second plurality of conductors 16 is a second plurality of wires 16. The main trunk 12 branches into a first branch 18 and a second branch 20. The first branch 18 and the second branch 20 extend from the main trunk 12. The first branch 18 includes the first plurality of wires 14 and the second branch 20 includes the second plurality of wires 16. The ends of the first plurality of wires 14 and the second plurality of wires 16 are terminated on each end by electrical connectors 22 which may be plug and/or socket type connectors or any type of electrical connector known to those skilled in the art.

The conductor harness assembly 10 further includes a unitary sheath 24 that is substantially planar and formed of a flexible material. The sheath 24 defines a first portion 26 that has a length and width that corresponds to the length and circumference of the first branch 18. A second portion 28 of the sheath 24 has a length and width that corresponds to a length and circumference of the second branch 20 and a third portion 30 of the sheath 24 has a length and width corresponding to a length and circumference of the main trunk 12. The lengths of these portions 26, 28, 30 are propositional to the lengths of the main trunk 12, first branch 18, and second branch 20 and may be longer or shorter than main trunk 12, first branch 18, and/or second branch 20. The width of the first, second, and third portion 26, 28, 30 of the sheath 24 will be greater than or equal to the circumference of the main trunk 12, first branch 18, and second branch 20 respectively. As used herein, substantially planar means that the ratio of the width of the first second, and third portion 26, 28, 30 to the thickness of the first second, and third portion 26, 28, 30 is at least 10:1 and the ratio of the length of the first second, and third portion 26, 28, 30 to the thickness of the first second, and third portion 26, 28, 30 is at least 50:1.

The sheath 24 could be constructed using various methods. Various materials or a single material can be cut from material stock in the required size and shape. The sheath 24 may be formed from a single piece of flexible material, such as a sheet of woven polyamide or aramid fiber by hand cutting, die cutting, or laser cutting. The sheath 24 could alternatively be formed by weaving the fiber into the desired shape. Alternatively, the sheath 24 may be formed from several pieces of material that are joined by processes such as sewing, knitting, adhesive bonding, or ultrasonic welding. Alternatively, the sheath 24 could be formed by spraying or injecting a flexible material such as a thermoplastic elastomer within a form or mold and curing the material. This method may allow easy use of adjacent materials or different material thickness in different locations within the sheath 24. Another method that could be used to form the sheath 24 is an additive manufacturing technique, e.g. stereolithography, also known as 3D printing. By using 3D printing techniques the form or mold would not be required and the joining of different materials would be simplified by being done as an integral part of the additive manufacturing process.

As illustrated in FIG. 1, during the assembly process the sheath 24 may be positioned within a wiring assembly fixture 35. Then the first and second plurality of wires 14, 16 are routed and collated as required by the length and shape of the wire harness assembly 10 to form the main trunk 12, the first branch 18, and the second branch 20.

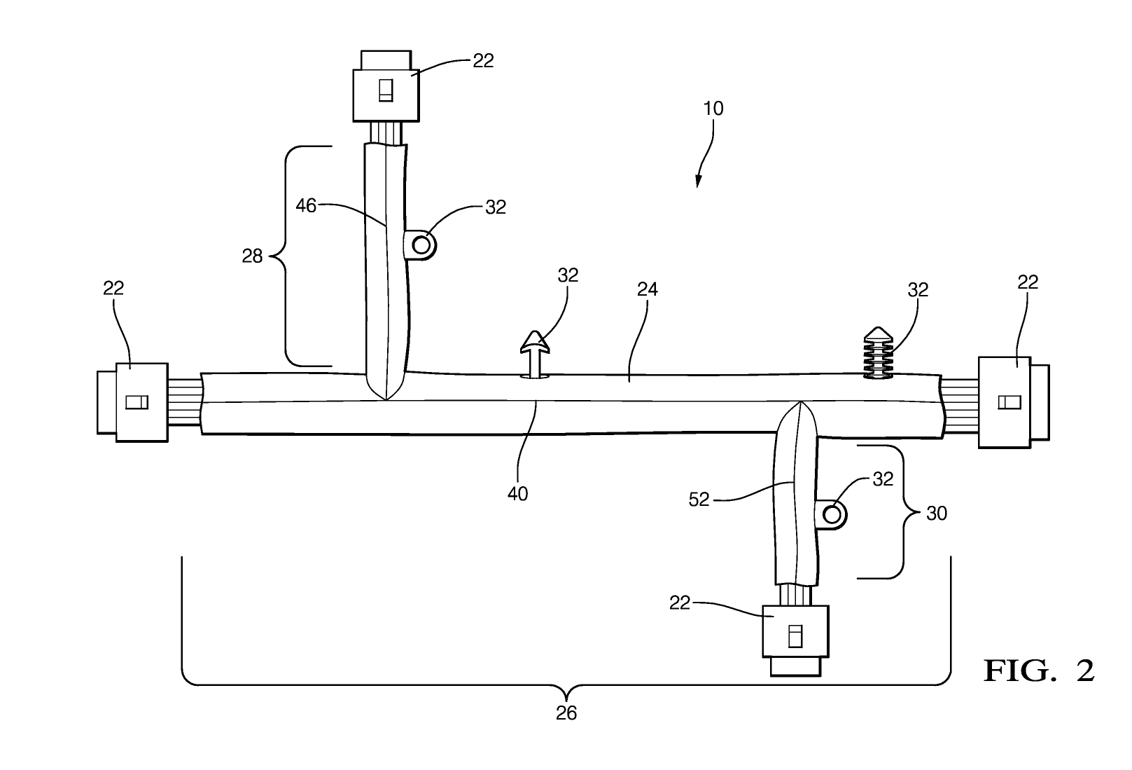

As illustrated in FIG. 2, the first portion 26 of the sheath 24 is circumferentially wrapped about the first branch 18, the second portion 28 of the sheath 24 is circumferentially wrapped about the second branch 20, and the third portion 26 of the sheath 24 is wrapped about the main trunk 12. The distal edge 36 of the first portion 26 overlaps the opposing distal edge 38 of the first portion 26 and is joined to the opposing distal edge 38 forming a first seam 40. The distal edge 42 of the second portion 28 overlaps the opposing distal edge 44 of the second portion 28 and is joined to the opposing distal edge 44 forming a second seam 46 and the distal edge 48 of the third portion 26 overlaps the opposing distal edge 50 of the third portion 26 and is joined to the opposing distal edge 50 forming a third seam 52. Each distal edge 36, 42, 48 is joined to each opposing distal edge 38, 44, 50 by processes such as sewing, knitting, adhesive bonding, or ultrasonic welding. For example the distal edges 36, 42, 48 opposing distal edge 38, 44, 50 and may be joined by a double sided adhesive tape 54.

As illustrated in FIG. 2, the wire harness assembly 10 may also include attachment features 32 such as threaded studs, barbed pins, perforated plates, “Christmas tree” fastener or other attachment means known to those skilled in the art integrally attached to the sheath 24. The attachment features 32 may protrude through cut outs 34 positioned in the sheath 24 as shown in FIG. 1 or they may be integrally formed in the sheath 24 by molding or an additive manufacturing process.

While the conductor harness assembly 10 described above included conductors that are wire cables that conduct electricity, other embodiments of the conductor harness assembly may be envisioned that include fiber optic cables that conduct light, hydraulic that conduct fluids, pneumatic tubes that conduct air pressure or a combination of any of these conductors. The example shown here has a main trunk and two branches. Other embodiments of the conductor harness assembly may be envisioned that have more than two branches or only a single main trunk.

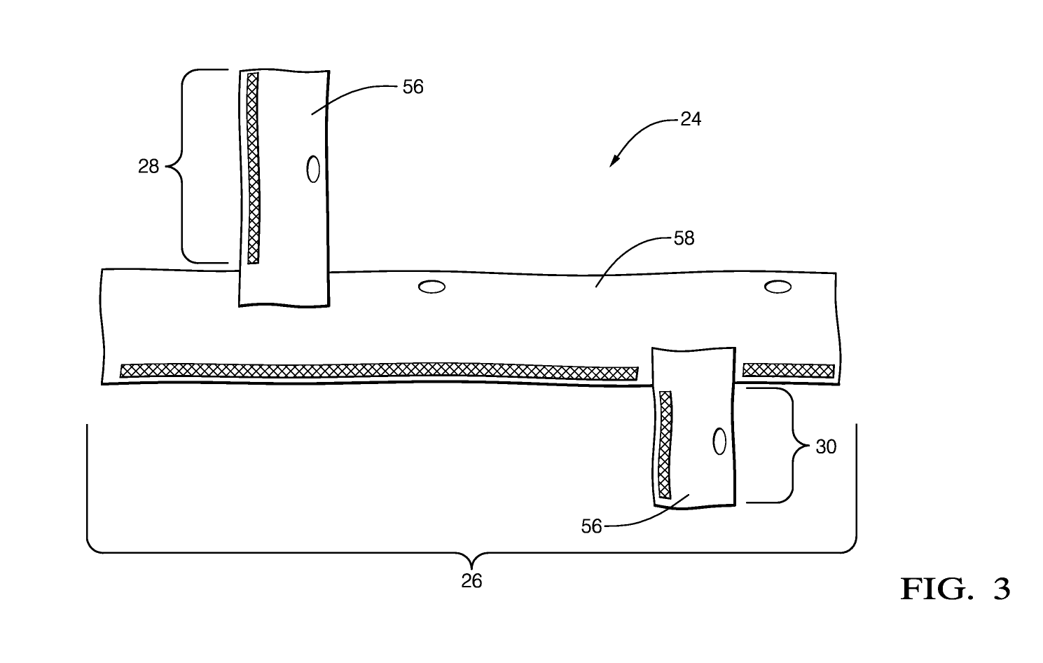

FIG. 3 illustrates non-limiting example of an alternative embodiment of the sheath 24 formed of sections 56 formed of a different material and/or different material thickness than the remainder 58 of the sheath 24. The material and thickness can be varied by sewing, knitting, adhesive bonding, or ultrasonic welding sections 56 formed of a different material and/or having different material thickness to the remainder 58 of the sheath 24. Alternatively the thickness of the material and the composition of the material forming the section of the sheath 24 could be varied when injecting or spraying the material within the form or mold or during the additive manufacturing process. Varying the thickness and/or material forming the sheath 24 may allow the section to be tailored to resistant environmental hazards such as abrasion, thermal, or radiation degradation.

Accordingly, a conductor harness assembly 10 is provided. The sheath 24 of the conductor harness assembly 10 provides a unitary component that bunches and collates the first and second plurality of conductors 14 into the main trunk 12, first branch 18 and second branch 20. The use of a unitary component to may simplify the harness assembly process by eliminating the application of tape and/or split conduit. The assembly may also include integral attachment features 32 that are configured to attach the assembly to a supporting structure, such as a motor vehicle body. Sections 56 of the material making up the sheath 24 and/or the thickness of the sheath 24 may be varied to accommodate varied environments. The sheath 24 may be formed of a flexible woven fabric and/or a flexible thermoelastic material. Depending on the material selected, the sheath 24 may be formed using a cutting, molding, or additive manufacturing process.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A conductor harness assembly, comprising:
a main trunk having a first plurality of conductors and a second plurality of conductors, said main trunk branching into a first branch and a second branch, wherein said first branch and said second branch extends from said main trunk and wherein said first branch includes said first plurality of conductors and said second branch includes said second plurality of conductors; and
a substantially planar sheath formed of a flexible material and defining a first portion having a length and width corresponding to a length and circumference of the first branch, a second portion having a length and width corresponding to a length and circumference of the second branch, and a third portion having a length and width corresponding to a length and circumference of the main trunk, wherein the first portion is circumferentially wrapped about the first branch, the second portion is circumferentially wrapped about the second branch, and the third portion is wrapped about the main trunk.

2. The conductor harness assembly in accordance with claim 1, wherein the sheath is formed of a woven fabric material.

3. The conductor harness assembly in accordance with claim 1, wherein the sheath is formed of a thermoelastic material.

4. The conductor harness assembly in accordance with claim 3, wherein the sheath is formed by a molding process.

5. The conductor harness assembly in accordance with claim 3, wherein the sheath is formed by an additive manufacturing process.

6. The conductor harness assembly in accordance with claim 1, wherein a segment of the sheath is formed of different material than the flexible material forming the remainder of the sheath.

7. The conductor harness assembly in accordance with claim 1, wherein a segment of the sheath has a different thickness than the flexible material forming the remainder of the sheath.

8. The conductor harness assembly in accordance with claim 1, wherein the first plurality of conductors is a first plurality of wires and the second plurality of conductors is a second plurality of wires.

9. The conductor harness assembly in accordance with claim 1, further comprising an attachment means integral to the sheath.

10. A wire harness assembly, comprising:
a main trunk having a first plurality of wires and a second plurality of wires, said main trunk branching into a first branch and a second branch, wherein said first branch and said second branch extends from said main trunk and wherein said first branch includes said first plurality of wires and said second branch includes said second plurality of wires; and
a substantially planar sheet of a flexible material defining a pattern including a first portion having a length and width corresponding to the length and circumference of the first branch, a second portion having a length and width corresponding to the length and circumference of the second branch, and a third portion having a length and width corresponding to the length and circumference of the main trunk, wherein the first portion is circumferentially wrapped about the first branch, the second portion is circumferentially wrapped about the second branch, and the third portion is wrapped about the main trunk.

11. The wire harness assembly in accordance with claim 10, wherein a segment of the sheath is formed of different material than the flexible material forming the remainder of the sheath.

12. The wire harness assembly in accordance with claim 10, wherein a segment of the sheath has a different thickness than the flexible material forming the remainder of the sheath.

13. The wire harness assembly in accordance with claim 10, wherein the sheath is formed of a thermoelastic material.

14. The wire harness assembly in accordance with claim 13, wherein the sheath is formed by a molding process.

15. The wire harness assembly in accordance with claim 14, further comprising an attachment means formed of a different material than the sheath and formed integrally with the sheath.

16. The wire harness assembly in accordance with claim 10, further comprising an attachment means formed of a different material than the sheath and formed integrally with the sheath.

17. The wire harness assembly in accordance with claim 16, wherein the sheath and the attachment means are formed by an additive manufacturing process.

18. The wire harness assembly in accordance with claim 10, wherein a distal edge of the first portion overlaps an opposing distal edge of the first portion and is joined to the opposing distal edge, a distal edge of the second portion overlaps an opposing distal edge of the second portion and is joined to the opposing distal edge, and a distal edge of the third portion overlaps an opposing distal edge of the third portion and is joined to the opposing distal edge.

19. The wire harness assembly in accordance with claim 18, wherein each distal edge is joined to each opposing distal edge by adhesive bonding.

20. A wire harness assembly, comprising:
a main trunk having a first plurality of wires and a second plurality of wires, wherein said main trunk branches into a first branch and a second branch, wherein said first branch and said second branch extends from said main trunk, and wherein said first branch includes said first plurality of wires and said second branch includes said second plurality of wires; and
a fabric material defining a pattern including a first portion having a length and width proportional to the length and circumference of the first branch, a second portion having a length and width proportional to the length and circumference of the second branch, and a third portion having a length and width proportional to the length and circumference of the main trunk, wherein the distal edges of the first portion are joined to circumferentially wrap the first branch, the distal edges of the second portion are joined to circumferentially wrap the second branch, and the distal edges of the third portion are joined to circumferentially wrap the main trunk.

21. The wire harness assembly in accordance with claim 20, wherein a segment of the sheath is formed of different material distinct from the fabric material forming the remainder of the sheath.

22. The wire harness assembly in accordance with claim 20, wherein a segment of the sheath is formed of a different fabric material having a different thickness than the fabric material forming the remainder of the sheath.

23. The wire harness assembly in accordance with claim 20, wherein a distal edge of the first portion overlaps an opposing distal edge of the first portion and is joined to the opposing distal edge, a distal edge of the second portion overlaps an opposing distal edge of the second portion and is joined to the opposing distal edge, and a distal edge of the third portion overlaps an opposing distal edge of the third portion and is joined to the opposing distal edge.

24. The wire harness assembly in accordance with claim 23, wherein each distal edge is joined to each opposing distal edge by an adhesive material.
